(19) United States
(12) Patent Application Publication
(10) Pub. No.: US 2026/0116820 A1
(43) Pub. Date: Apr. 30, 2026

(54) Method for preparing early-strength liquid accelerator free of alkali, chlorine, fluorine

(71) Applicants: CENTRAL SOUTH UNIVERSITY, Changsha (CN); CHINA RAILWAY GROUP LIMITED, Beijing (CN); NATIONAL ENGINEERING RESEARCH CENTER OF HIGH-SPEED RAILWAY CONSTRUCTION TECHNOLOGY, Changsha (CN); CHINA RAILWAY NO.10 ENGINEERING GROUP CO., LTD., Jinan (CN)

(72) Inventors: Qiang YUAN, Changsha (CN); Yi TIAN, Changsha (CN); Dapeng LU, Jinan (CN); Chaolong HU, Jinan (CN); Lei CHEN, Jinan (CN); Zhiwu YU, Changsha (CN); Jun WU, Beijing (CN); Sui TAN, Changsha (CN)

(21) Appl. No.: 19/120,561

(22) PCT Filed: Oct. 26, 2023
(86) PCT No.: PCT/CN2023/126785

§ 371 Date: Apr. 11, 2025

(30) Foreign Application Priority Data
Nov. 4, 2022 (CN) 202211377410.9

(51) Int. Cl. C04B 22/14; C04B 24/04; C04B 24/06; C04B 24/12; C04B 24/32; C04B 40/00; C04B 103/12; C04B 103/14

(52) U.S. Cl. CPC C04B 22/148; C04B 24/04; C04B 24/06; C04B 24/122; C04B 24/123; C04B 24/32; C04B 40/0046; C04B 2103/12; C04B 2103/14

(57) ABSTRACT

The present invention provides a method for preparing an early-strength liquid accelerator free of alkali, chlorine, and fluorine. In percentage by mass and on the basis of the sum of the usage amounts of aluminum sulfate, diethanolamine, a pH regulator, a complexing agent, Tween 20, and water, aluminum sulfate accounts for 56%-58%, diethanolamine accounts for 5%-6%, the pH regulator accounts for 0.7%-0.8%, the complexing agent accounts for 1.3%-1.4%, Tween 20 accounts for 0.6%-0.8%, and the remainder is water. The preparation method comprises: after uniformly mixing water, a pH regulator, and a complexing agent, adding the mixture into a reaction kettle, and heating the reaction kettle; adding aluminum sulfate into the reaction kettle, and stirring the mixture until the aluminum sulfate is completely dissolved; adding diethanolamine into the reaction kettle to obtain a premix; and adding tween 20 into the premix to obtain a liquid accelerator. The liquid accelerator prepared in the present invention also achieves the effect of being free of alkali, chlorine, and fluorine while ensuring the effects of rapid setting, early strength, and stability.

### CROSS REFERENCE TO RELATED APPLICATIONS

The present application claims the benefit of Chinese patent application 202211377410.9, filed on Nov. 4, 2022, the contents of which are incorporated herein by reference.

### FIELD OF THE INVENTION

The invention relates to the technical field of building materials, in particular to a method for preparing an early-strength liquid accelerator free of alkali, chlorine, and fluorine.

### BACKGROUND OF THE INVENTION

The sprayed concrete is a special concrete with supporting and reinforcing functions widely applied to tunnel engineering, wherein the accelerator is an additive essential for quickly setting and hardening the concrete. The accelerator is classified into a powder accelerator and a liquid accelerator according to the state of the accelerator. The powder accelerator is mainly applied to a dry spraying construction process, and the process can generate a large amount of dust, so that the powder accelerator not only has great harm to the health of workers, but also can generate serious environmental pollution. Therefore, liquid accelerators suitable for wet spraying processes have become a major development direction, especially early-strength accelerators. Therefore, when the China State Railway Group Co., Ltd. standard Q/CR807-2020 “Liquid alkali-free flash setting admixture for shotcrete of tunnels” requires that the mixing amount of the liquid accelerator in cement is 6%-8%, the formed mortar needs to have the strength of more than 1.0 MPa (including 1.0 MPa) for 6 hours.

The main quick-setting component of the liquid accelerator is aluminum sulfate, and in order to enable the strength of the mortar to reach more than 1.0 MPa after 6 hours, the applicant adopts a single-component test to determine that the mixing amount of the aluminum sulfate is more than 4.5% (percentage of the aluminum sulfate to the cement mass). When the mixing amount of the liquid accelerator is 8%, the concentration of aluminum sulfate is required to exceed 56%. However, the solubility of aluminum sulfate at ordinary temperature is only 36 g/100 g of water, which means that the liquid accelerator will crystallize, leading to poor stability issues. Therefore, the key to the development of alkali-free liquid accelerators is to solve the contradiction between the early strength and the stability of the liquid accelerators.

In order to solve the problems of quick setting and early strength, the alkali metal is doped to promote the hydration of cement. However, the incorporation of alkali metals not only brings about a corrosive environment, but also is not favorable for the development of later strength of concrete, and more importantly brings about the risk of alkali aggregate reaction. Therefore, the application prospect of the high-alkali liquid accelerator is limited. In addition, the researchers also considered incorporating chloride ions, but the risk of steel reinforcement corrosion induced by chloride ions is similarly difficult to avert. The effective content of aluminum ions in the setting accelerator is the primary factor that promotes the setting and hardening of cement concrete. The use of complexation technology is a significant technical approach to increase the effective content of aluminum ions. Currently, the complexing agent mainly used is fluoride ions; however, they also pose certain environmental concerns. Therefore, from the perspectives of durability and environmental protection, it is required that the setting accelerator be free of alkali, chlorine, and fluorine.

### DESCRIPTION OF THE INVENTION

The invention aims to provide a method for preparing an early-strength liquid accelerator free of alkali, chlorine, and fluorine. By combining a pH regulator and a complexing agent with specific components, the concentration of effective aluminum ions in the liquid accelerator can be increased, thereby achieving the early-strength effect of the liquid accelerator within 6 hours. Additionally, the use of an appropriate amount of stabilizer can enhance the stability of the liquid accelerator. The specific technical scheme is as follows:
the application provides a method for preparing an early-strength liquid accelerator free of alkali, chlorine, and fluorine, which comprises the following steps:
step S1, mixing water, a pH regulator and a complexing agent, adding the mixture into a reaction kettle, heating the reaction kettle to 70° C.-80° C., and preserving heat;
step S2, adding aluminum sulfate into the reaction kettle and stirring until the aluminum sulfate is completely dissolved;
step S3, adding diethanolamine into the reaction kettle to obtain a premix, and stirring the premix to be in a liquid state;
step S4, adding Tween 20 into the premix to prepare a complete mixed material, then stopping heat preservation of the reaction kettle, and stirring and cooling the complete mixed material to prepare the early-strength liquid accelerator free of alkali, chlorine, and fluorine;
in percentage by mass and on the basis of the sum of the usage amounts of aluminum sulfate, diethanolamine, a pH regulator, a complexing agent, Tween 20, and water, aluminum sulfate accounts for 56%-58%, diethanolamine accounts for 5%-6%, the pH regulator accounts for 0.7%-0.8%, the complexing agent accounts for 1.3%-1.4%, Tween 20 accounts for 0.6%-0.8%, and the remainder is water;
wherein the pH regulator comprises any one of tartaric acid and formic acid;
the complexing agent comprises any one of aspartic acid and methylglycine.

Alternatively, the aluminum sulfate meets the requirements of HG/T2225-2018 “Aluminum sulfate for industrial use”.

Alternatively, the diethanolamine meets the requirements of HG/T2916-1997 “Diethanolamine for industrial use”.

Optionally, in step S2, the following stirring parameters are used for the aluminum sulfate: stirring for not less than 30 minutes; the stirring rate is not less than 300 rpm.

Optionally, in step S3, the stirring time of the premix is 30-60 minutes, and the stirring rate is not less than 300 rpm.

Optionally, in step S4, the stirring time of the complete mixed material is not less than 30 minutes, and the stirring rate is not less than 300 rpm.

The technical scheme of the invention at least has the following beneficial effects:
(1) according to the method for preparing an early-strength liquid accelerator free of alkali, chlorine, and fluorine, tartaric acid or formic acid is used as a pH regulator, so that the solubility of aluminum sulfate can be increased, and the content of aluminum ions can be improved. Meanwhile, aspartic acid or methylglycine is used as a complexing agent, so that the blocking performance of dissolved aluminum ions can be improved, the concentration of the complexed aluminum ions is effectively increased, the crystallization and precipitation of the aluminum ions are prevented, and the 6 h early-strength performance of the liquid accelerator is favorably improved. The stabilizer with proper dosage is adopted, so that the stability of the liquid accelerator can be improved. And the diethanolamine with proper dosage is adopted, so that the net slurry setting time of the mortar can be shortened, and meanwhile, the 6 h early-strength performance can be improved. In addition, the pH regulator and the complexing agent with specific components are combined in the raw material components, and alkali metal, chloride ions and fluoride ions are not used, so that the liquid accelerator prepared in the present invention also achieves the effect of being free of alkali, chlorine, and fluorine while ensuring the effects of rapid setting, early strength, and stability.
(2) according to the method for preparing an early-strength liquid accelerator free of alkali, chlorine, and fluorine, Step S1 is employed to ensure that the pH regulator and the complexing agent are heated in the reactor to achieve optimal dissolution and complexation conditions for aluminum sulfate. Step S2 involves adding aluminum sulfate to the reactor to ensure its thorough dissolution and complexation. Step S3 incorporates diethanolamine to facilitate the preparation of a liquid premix, which also aids in the subsequent addition of the stabilizer Tween 20 in Step S4, resulting in a stable, alkali-free, chlorine-free, and fluorine-free early-strength liquid accelerator. Furthermore, the use of Tween 20 in Step S4 enhances the solubilization effect of the various components.

### DETAILED DESCRIPTION OF THE PREFERRED EMBODIMENTS

The technical solutions of the present invention will be described clearly and completely in conjunction with the embodiments of the invention. It is evident that the described embodiments represent only a portion of the invention's examples and not all possible embodiments. Based on the embodiments provided in this invention, all other embodiments obtained by those of ordinary skill in the art fall within the scope of protection of the present invention.

### Example 1

an early-strength liquid accelerator free of alkali, chlorine, and fluorine comprises the following raw material components in percentage by mass: 56% of aluminum sulfate; 5.5% of diethanolamine; 0.7% of pH regulator; 1.3% of complexing agent; 0.8% of stabilizer; and the remainder is water;

wherein the pH regulator is tartaric acid;

the complexing agent is aspartic acid.

The stabilizer is Tween 20.
the aluminum sulfate meets the requirements of HG/T2225-2018 “Aluminum sulfate for industrial use”.
the diethanolamine meets the requirements of HG/T2916-1997 “Diethanolamine for industrial use”.

A method for preparing an early-strength liquid accelerator free of alkali, chlorine, and fluorine, which comprises the following steps:
step S1, mixing water, a pH regulator and a complexing agent, adding the mixture into a reaction kettle, heating the reaction kettle to 70° C., and preserving heat;
step S2, adding aluminum sulfate into the reaction kettle and stirring until the aluminum sulfate is completely dissolved;
step S3, adding diethanolamine into the reaction kettle to obtain a premix, and stirring the premix to be in a liquid state;
step S4, adding Tween 20 into the premix to prepare a complete mixed material, then stopping heat preservation of the reaction kettle, and stirring and cooling the complete mixed material to prepare the early-strength liquid accelerator free of alkali, chlorine, and fluorine.

In step S2, the following stirring parameters are used for the aluminum sulfate: stirring for not less than 30 minutes; the stirring rate is not less than 300 rpm.

In step S3, the stirring time of the premix is 30-60 minutes, and the stirring rate is not less than 300 rpm.

In step S4, the stirring time of the complete mixed material is not less than 30 minutes, and the stirring rate is not less than 300 rpm.

The invention also provides example 2-10 and comparative example 1-10. In contrast to example 1, example 2-10 and comparative example 1-10 were adjusted in terms of the composition and amount of the starting materials, as detailed in table 1.

TABLE 1

| | Aluminum | Diethanol- | | Complexing | Stabilizer/ | Water/ |
|---|---|---|---|---|---|---|
| Number of | sulfate/wt % | amine/wt % | pH regulator/wt % | agent/wt % | wt % | wt. % |
| Example 1 | 56 | 5.5 | 0.7 (tartaric acid) | 1.3 (aspartic acid) | 0.8 (Tween 20) | 35.7 |
| Example 2 | 57 | 5.5 | 0.7 (tartaric acid) | 1.3 (aspartic acid) | 0.8 (Tween 20) | 34.7 |
| Example 3 | 57 | 5.5 | 0.7 (tartaric acid) | 1.3 (methylglycine) | 0.8 (Tween 20) | 34.7 |
| Example 4 | 57 | 5 | 0.7 (tartaric acid) | 1.3 (aspartic acid) | 0.8 (Tween 20) | 35.2 |
| Example 5 | 57 | 6 | 0.7 (tartaric acid) | 1.3 (aspartic acid) | 0.8 (Tween 20) | 34.2 |
| Example 6 | 57 | 5.5 | 0.8 (formic acid) | 1.3 (aspartic acid) | 0.8 (Tween 20) | 34.6 |
| Example 7 | 57 | 5.5 | 0.7 (formic acid) | 1.2 (methylglycine) | 0.8 (Tween 20) | 34.8 |
| Example 8 | 57 | 5.5 | 0.7 (formic acid) | 1.4 (aspartic acid) | 0.8 (Tween 20) | 34.6 |
| Example 9 | 57 | 5.5 | 0.7 (formic acid) | 1.3 (methylglycine) | 0.7 (Tween 20) | 34.8 |
| Example 10 | 57 | 5.5 | 0.7 (tartaric acid) | 1.3 (aspartic acid) | 0.6 (Tween 20) | 34.9 |
| Comparative | 55.5 | 5.5 | 0.7 (tartaric acid) | 1.3 (methylglycine) | 0.8 (Tween 20) | 36.2 |
| example 1 | | | | | | |
| Comparative | 58.5 | 5.5 | 0.7 (tartaric acid) | 1.3 (methylglycine) | 0.8 (Tween 20) | 33.2 |
| example 2 | | | | | | |
| Comparative | 57 | 4.5 | 0.7 (formic acid) | 1.3 (aspartic acid) | 0.8 (Tween 20) | 35.7 |
| example 3 | | | | | | |
| Comparative | 57 | 6.5 | 0.7 (formic acid) | 1.3 (methylglycine) | 0.8 (Tween 20) | 33.7 |
| example 4 | | | | | | |
| Comparative | 57 | 5.5 | 0.7 (phosphoric acid) | 1.3 (aspartic acid) | 0.8 (Tween 20) | 34.7 |
| example 5 | | | | | | |
| Comparative | 57 | 5.5 | 0.7 (sulfuric acid) | 1.3 (aspartic acid) | 0.8 (Tween 20) | 34.7 |
| example 6 | | | | | | |
| Comparative | 57 | 5.5 | 0.7 (tartaric acid) | 1.1 (aspartic acid) | 0.8 (Tween 20) | 34.9 |
| example 7 | | | | | | |
| Comparative | 57 | 5.5 | 0.7 (tartaric acid) | 1.5 (aspartic acid) | 0.8 (Tween 20) | 34.5 |
| example 8 | | | | | | |
| Comparative | 57 | 5.5 | 0.7 (tartaric acid) | 1.3 (aspartic acid) | 0.5 (Tween 20) | 35 |
| example 9 | | | | | | |
| Comparative | 57 | 5.5 | 0.7 (tartaric acid) | 1.3 (aspartic acid) | 0.8 (Tween 40) | 34.7 |
| example 10 | | | | | | |

Each of the early-strength liquid accelerator free of alkali, chlorine, and fluorine prepared in example 1-10 was designated as Sample 1-10. Each liquid accelerator prepared by comparative example 1-10 was correspondingly labeled as Comparative sample 1-10. The Sample 1-10 and the Comparative sample 1-10 are tested according to the accelerator density, pH value, solid content, stability, chloride ion content and alkali content test methods specified in GB/T35159-2017 “Flash setting admixtures for shotcrete”, and the Sample 1-10 and the Comparative sample 1-10 are tested according to the fluoride ion content test method specified in Q/CR807-2020 “Liquid alkali-free flash setting admixture for shotcrete of tunnels”. The results of the above tests are detailed in table 2.

TABLE 2

| | | | | | Chloride | Alkali | Fluoride |
|---|---|---|---|---|---|---|---|
| | Density | pH | Solid | | ion content | content | ion content |
| | (g/cm³) | value | content (%) | Stability | (%) | (%) | (%) |
| Standard | — | ≥2.0 | — | ≤5 mL | ≤0.1 | ≤1.0 | ≤0.05 |
| requirements | | | | | | | |
| Sample 1 | 1.41 | 3.1 | 41.3 | 1 | 0 | 0.1 | 0 |
| Sample 2 | 1.42 | 3.1 | 42.1 | 1 | 0 | 0.1 | 0 |
| Sample 3 | 1.42 | 3.1 | 42.4 | 2 | 0 | 0.1 | 0 |
| Sample 4 | 1.39 | 3.1 | 40.3 | 0 | 0 | 0.1 | 0 |
| Sample 5 | 1.44 | 3.2 | 43.1 | 0 | 0 | 0.1 | 0 |
| Sample 6 | 1.42 | 3.1 | 41.9 | 2 | 0 | 0.1 | 0 |
| Sample 7 | 1.42 | 3.9 | 42.3 | 3 | 0 | 0.1 | 0 |
| Sample 8 | 1.42 | 2.9 | 42.1 | 2 | 0 | 0.1 | 0 |
| Sample 9 | 1.42 | 3.2 | 42.1 | 1 | 0 | 0.1 | 0 |
| Sample10 | 1.42 | 3.1 | 42.1 | 0 | 0 | 0.1 | 0 |
| Comparative | 1.40 | 3.1 | 41.3 | 0 | 0 | 0.1 | 0 |
| sample 1 | | | | | | | |
| Comparative | 1.44 | 3.1 | 43.1 | 25 | 0 | 0.1 | 0 |
| sample 2 | | | | | | | |
| Comparative | 1.42 | 3.1 | 42.4 | 2 | 0 | 0.1 | 0 |
| sample 3 | | | | | | | |
| Comparative | 1.42 | 3.1 | 40.3 | 15 | 0 | 0.1 | 0 |
| sample 4 | | | | | | | |
| Comparative | 1.41 | 3.2 | 41.1 | 20 | 0 | 0.1 | 0 |
| sample 5 | | | | | | | |
| Comparative | 1.42 | 3.0 | 41.4 | 35 | 0 | 0.1 | 0 |
| sample 6 | | | | | | | |
| Comparative | 1.41 | 3.4 | 41.3 | 15 | 0 | 0.1 | 0 |
| sample 7 | | | | | | | |
| Comparative | 1.41 | 3.2 | 40.9 | 3 | 0 | 0.1 | 0 |
| sample 8 | | | | | | | |
| Comparative | 1.42 | 3.2 | 41.5 | 15 | 0 | 0.1 | 0 |
| sample 9 | | | | | | | |
| Comparative | 1.42 | 3.1 | 42.1 | 10 | 0 | 0.1 | 0 |
| sample 10 | | | | | | | |

According to the detection method specified in GB/T35159-2017 “Flash setting admixtures for shotcrete”, the Sample 1-10 and the comparative Sample 1-10 are tested for setting time of cement paste and compressive strength of mortar by using P.I 42.5 standard portland cement and standard sand produced by XIAMEN ISO STANDARD SAND CO., LTD., and the test results are detailed in Table 3.

TABLE 3

| | Setting time of | | | | | |
|---|---|---|---|---|---|---|
| | cement paste | | Compressive strength of mortar | | | |
| | Initial | Final | 6 h | 1 d | | 90 d |
| | setting | setting | compressive | compressive | 28 d | strength |
| | time | time | strength | strength | strength | retention |
| | (min) | (min) | (MPa) | (MPa) | ratio (%) | (%) |
| Standard requirements | ≤5 | ≤12 | ≥1.0 | ≥7.0 | ≥90 | ≥100 |
| Sample 1 | 1.3 | 4.5 | 1.5 | 15.2 | 106 | 112 |
| Sample 2 | 1.3 | 3.5 | 1.7 | 16.8 | 100 | 112 |
| Sample 3 | 1.2 | 3.2 | 1.8 | 16.5 | 103 | 118 |
| Sample 4 | 1.5 | 3.6 | 1.5 | 9.6 | 108 | 110 |
| Sample 5 | 1.3 | 5.5 | 1.6 | 8.4 | 96 | 104 |
| Sample 6 | 2.8 | 6.5 | 1.2 | 9.0 | 98 | 110 |
| Sample 7 | 2.0 | 5.4 | 1.3 | 14.8 | 100 | 106 |
| Sample 8 | 2.4 | 4.5 | 1.6 | 13.2 | 99 | 104 |
| Sample 9 | 2.1 | 4.4 | 1.5 | 10.2 | 102 | 110 |
| Sample10 | 1.6 | 3.8 | 1.7 | 14.2 | 100 | 112 |
| Comparative sample 1 | 3.5 | 9.6 | 0.7 | 10.6 | 107 | 110 |
| Comparative sample 2 | 6.3 | 25.6 | 0.6 | 9.4 | 97 | 105 |
| Comparative sample 3 | 5.8 | 23 | 0.4 | 10.8 | 97 | 112 |
| Comparative sample 4 | 7.0 | 32.4 | 0.5 | 6.4 | 96 | 104 |
| Comparative sample 5 | 4.4 | 16.5 | 0.8 | 13.2 | 100 | 106 |
| Comparative sample 6 | 7.1 | 28.4 | 0.5 | 10.2 | 102 | 110 |
| Comparative sample 7 | 8.0 | 35.4 | 0.6 | 14.8 | 101 | 106 |
| Comparative sample 8 | 6.5 | 24.5 | 0.4 | 13.2 | 99 | 104 |
| Comparative sample 9 | 6.0 | 23.4 | 0.5 | 10.2 | 102 | 110 |
| Comparative sample 10 | 5.5 | 33.8 | 0.7 | 14.2 | 100 | 107 |

From the content in Tables 1 to 3, it can be seen that:
the chloride ion content and the alkali content of the Sample 1-10 prepared by the invention are lower than the requirements of the Chinese national standard GB/T35159-2017, the fluorine ion content is also lower than the requirements of Q/CR807-2020, and the Sample stability is good. Therefore, the early-strength liquid accelerator free of alkali, chlorine, and fluorine can be prepared. The Sample 1-10 prepared by the invention meets the requirements of 1d compressive strength, 28d strength ratio and 90d strength retention value specified in the national standard GB/T35159-2017, the 6 h compressive strength is far higher than the requirement specified in Q/CR807-2020, and the excellent early strength performance is shown.

In Comparative Sample 1, the content of aluminum sulfate was reduced, which exhibited better stability. Its pH value, stability, chloride ion content, alkali content, fluoride ion content, and setting and hardening properties also met the requirements of GB/T 35159-2017 “Flash setting admixtures for shotcrete”. However, the 6-hour compressive strength was only 0.7 MPa, which did not meet the requirements of Q/CR 807-2020 “Liquid alkali-free flash setting admixture for shotcrete of tunnels”, indicating insufficient early strength performance.

In Comparative Sample 2, the content of aluminum sulfate was increased, leading to the formation of crystalline precipitates, which reduced stability. At the same time, the precipitated aluminum sulfate did not participate in the hydration reaction of cement, meaning the effective aluminum phase content in Comparative Sample 2 was reduced. As a result, the setting time of cement paste was prolonged, and the 6-hour compressive strength decreased, failing to meet the requirements for an early-strength accelerator.

In Comparative Sample 3, the content of diethanolamine was reduced. Although it exhibited good stability, the setting time of cement paste was prolonged, and the 6-hour compressive strength was 0.4 MPa, which did not meet the requirements for an early-strength accelerator.

In Comparative Sample 4, the content of diethanolamine was increased. The increase in diethanolamine content negatively affected the setting and hardening of cement, resulting in prolonged setting time of cement paste and reduced 6-hour compressive strength, failing to meet the requirements for an early-strength accelerator.

In Comparative Sample 5, the pH regulator was changed from tartaric acid to phosphoric acid. Due to the poor solubility of aluminum sulfate in phosphoric acid, crystalline substances formed in Comparative Sample 5, leading to reduced stability, prolonged setting time of cement paste, and decreased early strength.

In Comparative Sample 6, the pH regulator was changed from tartaric acid to sulfuric acid. This was equivalent to increasing the concentration of sulfate ions in a saturated aluminum sulfate solution, which also caused aluminum sulfate to crystallize in Comparative Sample 6, resulting in reduced stability, prolonged setting time of cement paste, and decreased early strength.

In Comparative Sample 7, the content of aspartic acid was reduced. When the amount of complexing agent was insufficient, aluminum ions could not be evenly dispersed, leading to stability issues in Comparative Sample 7. The crystallization and precipitation of aluminum sulfate reduced the amount of aluminum sulfate participating in the reaction, resulting in prolonged setting time of cement paste and decreased early strength.

In Comparative Sample 8, the content of aspartic acid was increased, which lowered the pH value of Comparative Sample 8 and delayed the hydration of cement. This led to prolonged setting time of cement paste, and the 6-hour compressive strength was only 0.4 MPa, failing to meet the requirements for an early-strength accelerator.

In Comparative Sample 9, the content of Tween 20 was reduced, causing aluminum sulfate to crystallize and precipitate, resulting in stability issues. Additionally, the setting time of cement paste was prolonged, and early strength decreased.

In Comparative Sample 10, Tween 20 was replaced with Tween 40, which also resulted in stability issues. The setting time of cement paste was prolonged, and the 6-hour compressive strength was 0.7 MPa, failing to meet the requirements for early strength.

To verify the compatibility of the early-strength liquid accelerator free of alkali, chlorine, and fluorine prepared by the present invention with different types of cement, 42.5-grade ordinary Portland cements produced by the following companies were selected: Guizhou Southwest Cement Co., Ltd., Shandong Yangchun Cement Co., Ltd., Hebei Jidong Cement Co., Ltd., Guangdong Jinyang Cement Co., Ltd., and Jiangxi Wannianqing Cement Co., Ltd. Sample 2 was used to conduct tests on the setting time of cement paste and the compressive strength of mortar for each of the aforementioned cements. The testing methods were carried out in accordance with the national standard GB/T 35159-2017 “Flash setting admixtures for shotcrete”. The dosage of Sample 2 was 8%, and the detailed test results are shown in Table 4.

TABLE 4

| | | Setting time of | | | | | |
|---|---|---|---|---|---|---|---|
| | | cement paste | | Compressive strength of mortar | | | |
| | | Initial | Final | 6 h | 1 d | | 90 d |
| | | setting | setting | compressive | compressive | 28 d | strength |
| | | time | time | strength | strength | strength | retention |
| | | (min) | (min) | (MPa) | (MPa) | ratio (%) | (%) |
| Standard requirements | | ≤5 | ≤12 | ≥1.0 | ≥7.0 | ≥90 | ≥100 |
| Sample 2 | Guizhou Southwest Cement | 2 | 6.5 | 1.7 | 19.3 | 100 | 112 |
| | Shandong Yangchun Cement | 2 | 8.8 | 1.1 | 13.3 | 102 | 115 |
| | Hebei Jidong Cement | 1.8 | 6.0 | 1.3 | 17.1 | 98 | 110 |
| | Guangdong Jinyang Cement | 2.0 | 6.2 | 1.6 | 16.2 | 103 | 108 |
| | Jiangxi Wannianqing Cement | 2.2 | 7.7 | 1.3 | 12.8 | 96 | 106 |

From Table 4, it can be observed that the early-strength liquid accelerator free of alkali, chlorine, and fluorine prepared by the present invention meets the requirements of both GB/T 35159-2017 and Q/CR 807-2020 in terms of the setting time of cement paste and the compressive strength of mortar for different types of cement, demonstrating excellent compatibility.

Based on Example 1, the present invention also conducted Comparative Examples 11 to 13, with specific schemes as follows:

### Comparative Example 11

Unlike Example 1, the stirring rate in steps S2 to S4 was set to 250 rpm.

### Comparative Example 12

Unlike Example 1, the reaction kettle in step S1 was heated to 60° C.

### Comparative Example 13

Unlike Example 1, the required amounts of water, pH regulator, complexing agent, aluminum sulfate, diethanolamine, and Tween 20 were added to the reaction kettle all at once.

Compared to Example 1, in Comparative Example 11, reducing the stirring rate resulted in 20 ml of sediment at the bottom of the prepared liquid accelerator after 28 days, and the 6-hour compressive strength was 0.7 MPa. This indicates that the prepared liquid accelerator exhibited poor stability and failed to meet the early-strength requirements.

Compared to Example 1, in Comparative Example 12, lowering the heating temperature reduced the dissolution rate of aluminum sulfate, resulting in 24 ml of sediment at the bottom of the prepared liquid accelerator after 28 days, and the 6-hour compressive strength was 0.6 MPa. This indicates that the prepared liquid accelerator exhibited poor stability and failed to meet the early-strength requirements.

Compared to Example 1, in Comparative Example 13, adding all materials at once prevented the components from being uniformly dispersed and dissolved in a timely manner. After stirring, the accelerator became paste-like, failing to meet the requirements for a liquid accelerator.

Based on Example 2, the present invention also conducted Comparative Example 14, with the specific scheme as follows:

### Comparative Example 14

Unlike Example 2, the complexing agent aspartic acid was replaced with an equal weight of glutamic acid.

Compared to Example 2, the liquid accelerator prepared in Comparative Example 14 exhibited 18 ml of sediment at the bottom after 28 days, and the 6-hour compressive strength was 0.8 MPa. The prepared liquid accelerator exhibited poor stability and failed to meet the early-strength requirements.

In summary, the present invention is capable of preparing an early-strength liquid accelerator free of alkali, chlorine, and fluorine, with a 6-hour compressive strength of up to 1.7 MPa, demonstrating excellent early-strength performance.

The above descriptions are merely preferred embodiments of the present invention and are not intended to limit the scope of the invention. For those skilled in the art, various modifications and changes can be made to the present invention. Any modifications, equivalent substitutions, or improvements made within the spirit and principles of the present invention shall be included within the scope of protection of the present invention.

What is claimed is:

1. A method for preparing an early-strength liquid accelerator free of alkali, chlorine, and fluorine, which comprises the following steps:
step S1, mixing water, a pH regulator and a complexing agent, adding the mixture into a reaction kettle, heating the reaction kettle to 70° C.-80° C., and preserving heat;
step S2, adding aluminum sulfate into the reaction kettle and stirring until the aluminum sulfate is completely dissolved;
step S3, adding diethanolamine into the reaction kettle to obtain a premix, and stirring the premix to be in a liquid state;
step S4, adding Tween 20 into the premix to prepare a complete mixed material, then stopping heat preservation of the reaction kettle, and stirring and cooling the complete mixed material to prepare the early-strength liquid accelerator free of alkali, chlorine, and fluorine;
in percentage by mass and on the basis of the sum of the usage amounts of aluminum sulfate, diethanolamine, a pH regulator, a complexing agent, Tween 20, and water, aluminum sulfate accounts for 56%-58%, diethanolamine accounts for 5%-6%, the pH regulator accounts for 0.7%-0.8%, the complexing agent accounts for 1.3%-1.4%, Tween 20 accounts for 0.6%-0.8%, and the remainder is water;
wherein the pH regulator comprises any one of tartaric acid and formic acid;
the complexing agent comprises any one of aspartic acid and methylglycine.

2. The method according to claim 1, wherein the aluminum sulfate meets the requirements of HG/T2225-2018 “Aluminum sulfate for industrial use”.

3. The method according to claim 1, wherein the diethanolamine meets the requirements of HG/T2916-1997 “Diethanolamine for industrial use”.

4. The method according to claim 1, wherein in step S2, the following stirring parameters are used for the aluminum sulfate: stirring for not less than 30 minutes; the stirring rate is not less than 300 rpm.

5. The method according to claim 1, wherein in step S3, the stirring time of the premix is 30-60 minutes, and the stirring rate is not less than 300 rpm.

6. The method according to claim 1, wherein in step S4, the stirring time of the complete mixed material is not less than 30 minutes, and the stirring rate is not less than 300 rpm.

7. The method according to claim 2, wherein in step S2, the following stirring parameters are used for the aluminum sulfate: stirring for not less than 30 minutes; the stirring rate is not less than 300 rpm.

8. The method according to claim 3, wherein in step S2, the following stirring parameters are used for the aluminum sulfate: stirring for not less than 30 minutes; the stirring rate is not less than 300 rpm.

9. The method according to claim 2, wherein in step S3, the stirring time of the premix is 30-60 minutes, and the stirring rate is not less than 300 rpm.

10. The method according to claim 3, wherein in step S3, the stirring time of the premix is 30-60 minutes, and the stirring rate is not less than 300 rpm.

11. The method according to claim 2, wherein in step S3, the stirring time of the premix is 30-60 minutes, and the stirring rate is not less than 300 rpm.

12. The method according to claim 3, wherein in step S3, the stirring time of the premix is 30-60 minutes, and the stirring rate is not less than 300 rpm.
